(19) United States
(12) Patent Application Publication
(10) Pub. No.: US 2007/0107277 A1
(43) Pub. Date: May 17, 2007

(54) SEAT IDENTIFICATION SYSTEM

(75) Inventors: Richard K. Simms, Redmond, WA (US); Dennis C. Lin, Everett, WA (US); Domenic S. Giuntoli, Seattle, WA (US); Heidi Kneller, Bellevue, WA (US); Peter R. Mitchell, Marysville, WA (US); Melanie Kimsey, Seattle, WA (US); Andrew D. Barr, Kirkland, WA (US); Mackenzie L. Belka, Seattle, WA (US); Heather L. Curtin, Renton, WA (US); Jonah S. Griffith, Seattle, WA (US); Jeffrey W. Ladwig, Seattle, WA (US); J. Travis Leckie, Redmond, WA (US); Jack R. Pflueger, Pacifica, CA (US); Olen T. Ronning, Seattle, WA (US); Darrin J. Seeds, Bellingham, WA (US); Ryan M. Smith, Bellingham, WA (US); Joseph P. Sullivan, Spokane, WA (US)

Correspondence Address: OSTRAGER CHONG FLAHERTY & BROITMAN, P.C., 250 PARK AVENUE, SUITE 825, NEW YORK, NY, 10177-0899, US

(73) Assignee: THE BOEING COMPANY, Chicago, IL (US)

(21) Appl. No.: 11/164,200

(22) Filed: Nov. 14, 2005

(51) Int. Cl. G09F 3/00

(52) U.S. Cl. 40/320

(57) ABSTRACT

A seat identification system for passengers in a cabin of a commercial airliner. Four sign components, identified as the aisle, mile, row and seat components, are arranged and positioned throughout the airplane in a configuration that allows the passengers to receive information about their seats when needed. The aisle signage markers direct the passengers down the appropriate aisle which leads to their seat. The interval row markers or mile markers provide a general location of the particular row in the aircraft for the passenger's seats. The individual row markers are preferably located in the passenger service unit modules and in viewing channels in order to allow the markers to be visible from the aisle. The seat markers are located preferably on the headrest on each seat and are the final vindication that the passenger is in the correct seat.

### TECHNICAL FIELD

The present invention relates to seating systems in passenger cabins for airliners and the like, and more particularly to seat identification systems for the passenger cabins.

### BACKGROUND OF THE INVENTION

Many types and locations of labels and indicators have been utilized by various aircraft manufacturers and airliners to assist the passengers in finding their assigned seats on the airplane. Typical systems create a correspondence between the seat row along the length of the fuselage of the aircraft and the seat letter which is horizontally transverse to the longitudinal direction of the length of the aircraft. The same information is typically printed on the passenger's boarding pass. Although such systems have been in use for some time, they still have a tendency to produce passenger anxiety and confusion, particularly for passengers who fly infrequently, and can result in higher workload for the airline attendants. In this regard, it is not uncommon for passengers to end up in the wrong seat and have to move, causing further inconvenience and delay in the boarding of the aircraft.

There are several disadvantages to current systems. The diagrams typically located on the signage are often hard to interpret. Also, the signage is typically non-lighted, which can create confusion in a dark or dimly lit passenger cabin. Moreover, the signage may be ambiguously placed on an overhead location, creating confusion for the passengers to actually identify their correct rows. Finally, the signage typically provides little guidance as to the precise seat to which the passenger is assigned.

### SUMMARY OF THE INVENTION

It is an object of the present invention to provide an improved seat identification system for passengers, particularly on commercial airliners. It is also an object of the present invention to provide a seat identification system that more clearly communicates seat locations to the passengers. It is a still further object of the present invention to provide a seat identification system that integrates with the aircraft architecture and also allows modifications of the interior configuration of the aircraft, such as seat pitch changes, classification changes, and aircraft architecture changes.

It is a still further object of the present invention to provide a seat identification system that meets airline requirements and also effectively reduces passenger anxiety, wrong seat occupancy, and attendant workload. It is an additional object of the present invention to provide a seat identification system that meets minimum requirements of cost and weight, as well as maintains the ability to reconfigure the aircraft interior where necessary.

In accordance with the present invention, an improved seat identification system is provided for a commercial passenger aircraft, particularly for a twin-aisle passenger aircraft, which meets the above objectives. These aircraft have outboard stowage/storage bins, and typically also have centerline (inboard) bins above the central rows of seats.

In accordance with the present invention, a seat identification system is provided which provides information to the passengers in various manners, beginning with broad aisle signage and ending with a specific seat address. The aisle signs are marked and provide the first directional lead toward the appropriate seat. The aisle indication also indicates the seat letter which will lead passengers down the correct aisle. The aisle markers can be positioned at various locations throughout the airplane, typically adjacent the passenger ingress doorways.

Along the aisles, additional signage is provided in the form of “mile” markers spaced at regular intervals, for example, five or ten rows apart. The markers are positioned to be viewed in crowded situations from both forward and aft directions and also are designed to integrate with the airplane architecture. These markers can provide passenger information as to the total number of rows in the cabin, as well as a general location of their particular row in the airplane.

The inventive system also provides more specific individual row markers adjacent each group of seats. The row markers can be positioned, for example, in the passenger service units (PSUs). For this purpose, viewing channels can be inset into the PSUs to make the information more readable and accessible.

Seat markers are also positioned on each of the seats in the passenger compartments. This allows the passengers to correctly identify the specific seats to which they have been assigned. The seat markers can be located on the headrest of each of the seats.

With the present invention, the new seat identification system more clearly communicates the seat locations to the passengers, integrates appropriately to the aircraft architecture, and allows for airline interior configuration modifications without diminishing the ability of the system to communicate the appropriate seat and seat location to the passengers.

### BRIEF DESCRIPTION OF THE DRAWINGS

FIG. 1 is a schematic prospective view of an airplane passenger compartment illustrating features of the present invention.

FIG. 2 is another perspective view of an aircraft passenger compartment illustrating a feature of the present invention.

FIG. 3 is a still further perspective view of an airline passenger compartment illustrating features of the present invention.

FIG. 4 illustrates still additional features of the present invention.

FIG. 5 is a close up view of a portion of the illustration shown in FIG. 4.

FIG. 6 illustrates an embodiment of seat markers in accordance with the present invention.

### DESCRIPTION OF THE PREFERRED EMBODIMENTS

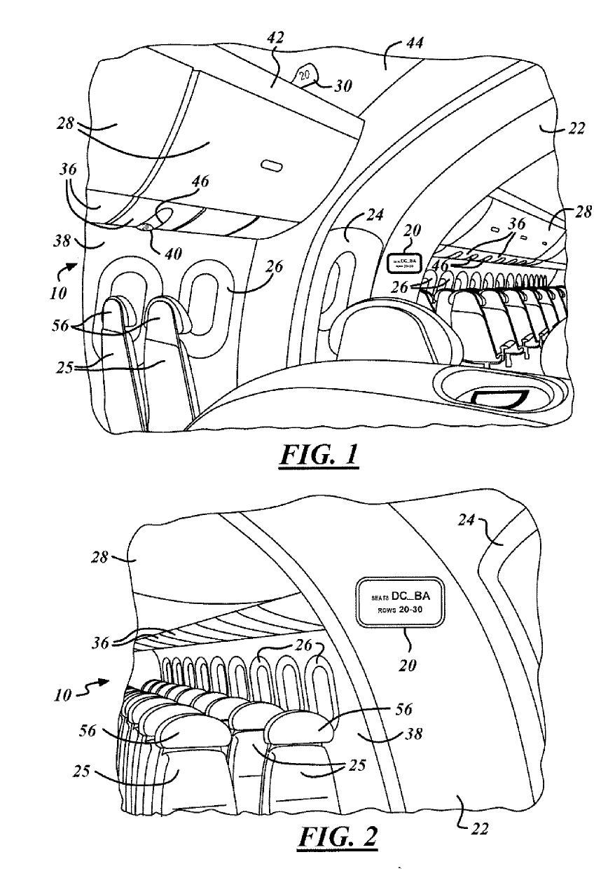

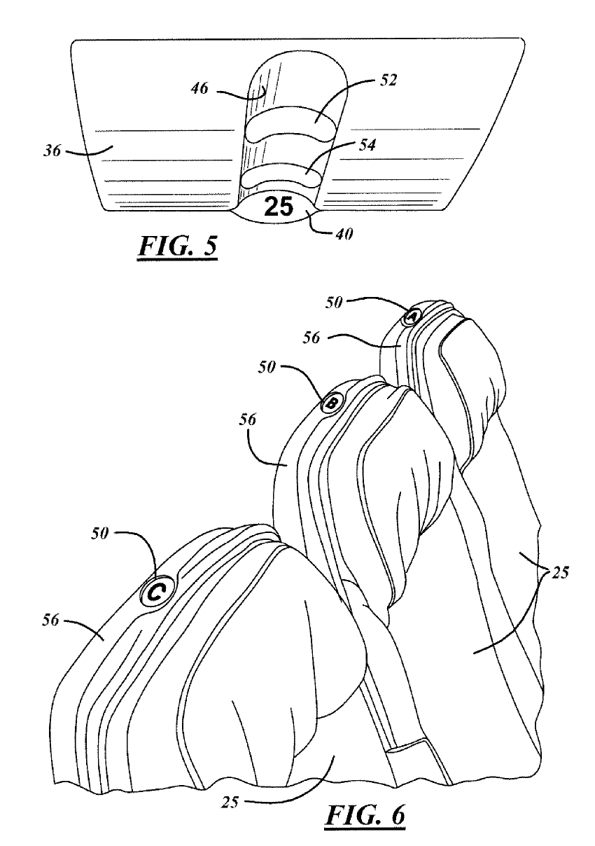

FIGS. 1-6 illustrate a preferred embodiment of the seat identification system in accordance with the present invention. The present invention provides guidance to passengers, particularly those on an airplane, to more easily find their seat when boarding or moving about an aircraft cabin, particularly a twin-aisle aircraft cabin. In the drawings, the aircraft cabin, which is shown schematically and is representative of cabins on all commercial airliners, is referred to by the reference numeral 10.

In accordance with a preferred embodiment of the invention, four signage components or markers are positioned throughout the airplane in a particular configuration that allow the passengers to receive information about their assigned seat in a better, faster, and more accurate manner. The four signage components or markers are referred to herein as aisle signage markers 20, internal row markers or “mile” markers 30, individual row markers 40 and seat markers 50. With the present invention, the passenger receives information when boarding or moving about the airplane in “chunks,” that is, the passenger is provided with various items of information which when taken in sequence and compiled together, provide easy reference and guidance to his or her seat. The information begins with broad aisle signage and ends with a specific seat address.

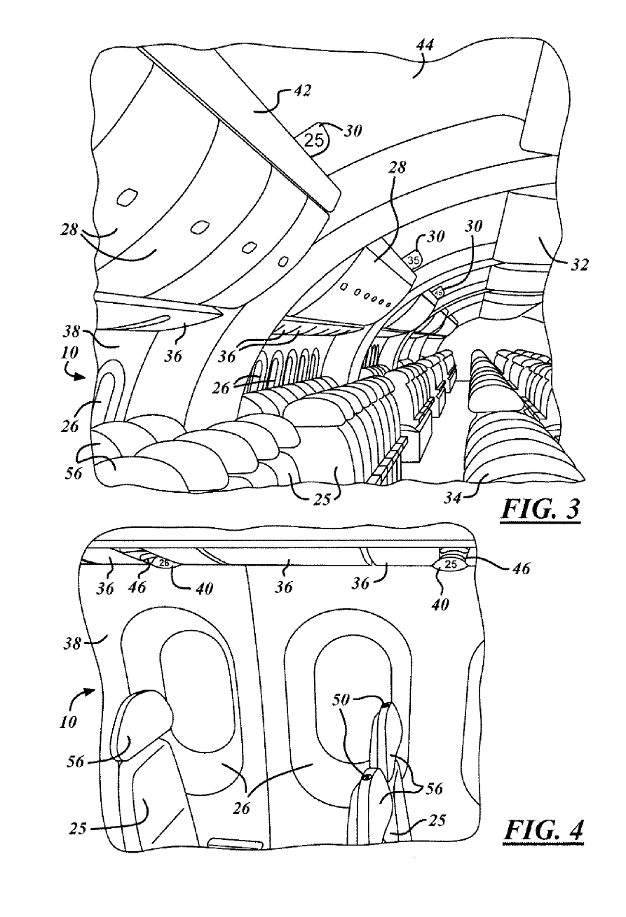

In accordance with a preferred embodiment of the invention, the aisle signage markers 20 are marked preferably by letters rather than numbers and are provided for viewing by the passengers as they first enter the aircraft. FIGS. 1 and 2 illustrate a representative aisle signage marker 20. As shown, the aisle markers 20 are positioned on bulk heads 22 in the passenger cabins and preferably near a door or entranceway 24. The passenger compartment also contains various rows of seats 25, a plurality of windows 26 on the exterior walls of the aircraft, and one or more rows of storage/stowage bins 28. The storage/stowage bins 28 shown in FIGS. 1-3 are the outboard storage/stowage bins and are positioned in rows along the length of the passenger compartments of the airplane. In twin aisle aircraft, which typically are the large airplanes or jumbo jets which handle 300-500 passengers, inboard storage/stowage bins 32 are typically provided above the center rows of passenger seats 34 (FIG. 3).

A plurality of passenger service unit (PSU) modules 36 are attached to the outer walls or attachment means of the airplane between the storage bins 28 and the walls 38 of the fuselage in which the windows 26 are positioned. The PSU modules contain the lights for the passenger, air nozzles, emergency masks, attendant call buttons, and the like. Positioned immediately above the outboard storage/stowage bins 28 are the environmental control system (ECS) modules 42. The ECS modules are positioned adjacent the ceiling panels 44. The ECS modules include the main passenger lighting, auxiliary air systems and the like.

As indicated, the aisle signage markers 20 are marked by letters and are the first directional lead that the passengers encounter as they board the airplane and would lead them toward their specific seat. By choosing the aisle that corresponds to the seat letter on the passenger's boarding pass, the aisle signage markers will lead the passenger down the correct aisle. For example, with reference to the aisle signage marker 20 as shown in FIGS. 1 and 2, a passenger seated in seat 28C would first be confronted by the aisle marker 20. The first item of identification marker that the passenger would look for would be the aisle marker with a “C” contained on it. This provides an additional piece of location signage without adding more numbers or letters to the system.

The aisle signage markers 20 are capable of being used in different locations through the plane. The aisle signage markers can be, for example, snap-fit assemblies back lit by multicolored LEDs with options for providing variable color and intensity.

After entering the correct aisle, the next visible signage for the passengers are the interval row markers or “mile” markers which are spaced at short intervals throughout the aircraft. For example, as shown in FIGS. 1 and 3, the mile markers 30 are spaced every ten rows apart. Preferably, the mile markers 30 are positioned above the storage/stowage bins 28, such as being attached to the ECS modules 42 as shown in FIGS. 1 and 3.

The mile markers preferably are positioned at a considerable height above the passenger seats 25 so that the markers are readable in crowded situations from both forward and aft directions. The mile markers also preferably integrate with the architecture of the passenger compartment 10 in the aircraft. Mile markers 30 help reduce boarding time, visual pollution, and user anxiety. The mile markers quickly give the passengers information as to the total number of rows, as well as the general location of their particular row in the airplane.

The mile marker or interval row markers 30 preferably are LED side-lit signs and are located above the outboard storage/stowage bins where the ECS modules meet the ceiling 44.

The interval row markers or mile markers 30 indicate groups of seats to the passenger. As an example, seat 28C would be located between markers 25 and 35 in FIG. 3. The mile markers 30 can have any shape, such as the curved shape shown in FIGS. 1 and 3. The mile marker signs 30 can be made of a two-piece snap-fit housing that would contain side mounted full spectrum RGB-LED lights. The light intensity can be varied to offer different effects for boarding and in-light ambience. Also, since the markers 30 are positioned between the ceiling and the overhead bins, the markers could be energized by the existing light system. As one example of a sign for a mile marker, two interchangeable numbered lenses can be fit directly into a sign housing on each side. The mile markers in the lenses can then be removed and replaced if the seating was reconfigured in any manner.

Once the passengers have reached their seat group, the more specific, individual row markers 40 become visible. Preferably, the row markers 40 are positioned in the PSU modules. By being located within the PSU modules, the row signage will always be located relative to a certain row of seats since the PSU module must be relocated with the seat if the seat pitch is changed.

In order to eliminate visual pollution and possible interference with the heads of the passengers, the individual row markers 40 preferably are positioned to blend in smoothly with the architecture of the aircraft. In this manner, a viewing channel 46 is inset into the PSU module 36 making the individual row markers 40 visible from the aisle in that respective row. The surface of the inset channel 46 can provide space for other passenger accessories, such as call lights 52 and reading lamps 54. The row lighting can also be activated by activating the attendant's call button. This would reduce visual pollution while remaining easily visible by the passengers or flight attendants when needed.

In one preferred embodiment, the individual row markers 40 comprise a co-molded lens back-lit by RGB LEDs inlaid into a molded housing. The row markers are preferably made of an opaque material and are attached directly into the PSU module for easy reconfiguration and visual interpretation. Similar row markers and viewing channels are positioned in the inboard PSU modules (not shown) which are positioned adjacent the inboard storage/stowage bins 32.

The seat markers 50 provide the final information necessary for the passenger to locate his or her specific seat. The seat markers 50 are preferably positioned on the headrests 56 of the passenger seats 25. Each seat marker 50 is slightly angled and positioned flush to the seats. This allows the marker to be seen easily from the aisle and keeps the seat markers from becoming visually distracting.

Preferably, the seat markers 50 consist of a plastic housing and interchangeable snap-fit inserts for easy reconfiguration. The seat markers 50, typically located at A, B, C, etc. provide the passenger with a positive seat address and should reduce wrong seat occupancy. Depending on the size and boldness of the font used for the various markers 20, 30, 40 and 50, a more effective hierarchy of signage is provided which guides the passengers from the time they board the airplane to the time they sit in their assigned seats.

The invention provides guidance to the seat in a quick and relatively easy manner and also significantly reduces boarding time. With the present invention, all of the various markers are visible to passengers regardless of whether the outboard/inboard storage/stowage bins are opened or closed. The seat identification system also is functional regardless of whether inboard storage/stowage bins are provided. The system thus works independently of the storage/stowage bins.

The seat identification system also can be easily understood by the passengers. Passengers should easily be able to understand the seat identification system, regardless of their culture, gender, age, flight experience, or the like. The inventive system clearly enables the passenger and the flight crew to identify the correct row and seat. The system is easily usable by passengers with disabilities. The system also provides seat identification even when the seats on the airplane are moved about or the seating arrangement is reconfigured.

The present invention is also usable in all ambient light conditions. If the markers are lit, the seat identification system provides the ability of the passenger and crew to find specific seats at night or in low light level conditions. The markers are also relatively inconspicuous except when they are needed.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A seat identification system for an aircraft having a plurality of passenger seats positioned in rows and a plurality of aisles, said seat identification system comprising:
at least one aisle marker;
at least one mile marker;
at least one row marker; and
at least one seat marker.

2. The seat identification system as described in claim 1 wherein said aircraft has at least one entrance door for passengers and said aisle member is positioned adjacent said entrance door.

3. The seat identification system as described in claim 1 wherein a plurality of mile markers are provided and said mile markers are positioned at intervals spaced apart by a prespecified number of rows of seats.

4. The seat identification system as described in claim 3 wherein said aircraft has a plurality of environmental control system members and wherein said mile markers are positioned adjacent said environmental control system members.

5. The seat identification system as described in claim 1 wherein said aircraft has at least one passenger service unit module and said row marker is positioned on said passenger service unit module.

6. The seat identification system as described in claim 5 further comprising a viewing channel in said passenger service unit module and wherein said row marker is positioned in said viewing channel.

7. The seat identification system as described in claim 1 wherein said seat marker is positioned on a passenger seat.

8. The seat identification system as described in claim 7 wherein said passenger seat has a headrest member and wherein said seat member is positioned on said headrest member.

9. The seat identification system as described in claim 1 wherein said aisle marker utilizes letters to identify specific aisles in the aircraft, said mile marker and row marker utilize numbers to identify specific rows of seats on the aircraft, and said seat marker utilizes letters to identify specific seats in said rows of seats.

10. A seat identification system for an aircraft having a plurality of passenger seats positioned in rows and separated by aisles, said system comprising:
a plurality of aisle markers;
a plurality of mile markers;
a plurality of row markers; and
a plurality of passenger seat markers.

11. The seat identification system as described in claim 10 wherein said aircraft has at least one ingress for passengers and said aisle member is positioned adjacent said ingress.

12. The seat identification system as described in claim 10 wherein said mile markers are positioned spaced apart a prespecified number of rows of seats.

13. The seat identification system as described in claim 12 wherein said aircraft has a plurality of environmental control system members and wherein said mile markers are positioned adjacent said environmental control system members.

14. The seat identification system as described in claim 10 wherein said aircraft has a plurality of passenger service unit modules and said row markers are positioned on said passenger service unit modules.

15. The seat identification system as described in claim 14 further comprising viewing channels in said passenger service unit modules and wherein said row markers are positioned in said viewing channels.

16. The seat identification system as described in claim 10 wherein said seat markers are positioned on said passenger seats.

17. The seat identification system as described in claim 16 wherein said passenger seats have a headrest members and wherein said seat members are positioned on said headrest members.

18. The seat identification system as described in claim 10 wherein said aisle markers utilize letters to identify specific aisles in the aircraft, said mile markers and row markers utilize numbers to identify specific rows of seats on the aircraft, and said seat markers utilize letters to identify specific seats in said rows of seats.

19. A seat identification system for an aircraft having a plurality of passenger seats positioned in rows and separated by aisles, said system comprising:
a plurality of aisle markers;
a plurality of row markers; and
a plurality of passenger seat markers.

20. The seat identification system as described in claim 19 wherein said aircraft has at least one ingress for passengers and at least one of said aisle members are positioned adjacent said ingress.

21. The seat identification system as described in claim 19 wherein said aircraft has a plurality of passenger service unit modules and said row markers are positioned on said passenger service unit modules.

22. The seat identification system as described in claim 19 wherein said seat markers are positioned on said passenger seats.

23. A seat identification system for an aircraft having a plurality of passenger seats positioned in rows and separated by aisles, said system comprising:
a plurality of mile markers;
a plurality of row markers; and
a plurality of passenger seat markers.

24. The seat identification system as described in claim 23 wherein said mile markers are positioned spaced apart a prespecified number of rows of seats.

25. The seat identification system as described in claim 24 wherein said aircraft has a plurality of environmental control system members and wherein said mile markers are positioned adjacent said environmental control system members.

26. The seat identification system as described in claim 23 wherein said aircraft has a plurality of passenger service unit modules and said row markers are positioned on said passenger service unit modules.

27. The seat identification system as described in claim 23 wherein said seat markers are positioned on said passenger seats.
